(19) United States
(12) Patent Application Publication
(10) Pub. No.: US 2024/0191111 A1
(43) Pub. Date: Jun. 13, 2024

(54) COATING COMPOSITIONS

(71) Applicant: PPG Industries Ohio, Inc., Cleveland, OH (US)

(72) Inventors: Masayuki Nakajima, Jr., Wexford, PA (US); Hongying Zhou, Allison Park, PA (US); Marvin Michael Pollum, Jr., Pittsburgh, PA (US); Loubna Pagnotti, Wexford, PA (US)

(73) Assignee: PPG Industries Ohio, Inc., Cleveland, OH (US)

(21) Appl. No.: 18/551,691

(22) PCT Filed: Mar. 23, 2022
(86) PCT No.: PCT/US2022/071273

§ 371 Date: Sep. 21, 2023

Related U.S. Application Data
(60) Provisional application No. 63/246,945, filed on Sep. 22, 2021.
(60) Provisional application No. 63/166,643, filed on Mar. 26, 2021.

(51) Int. Cl. C09J 163/00; C08G 59/40; C08G 63/91

(52) U.S. Cl. CPC C09J 163/00; C08G 59/4021; C08G 63/912

(57) ABSTRACT

Disclosed herein are compositions comprising an epoxy-functional polyester, elastomeric particles, and an accelerator. The epoxy-functional polyester comprises a reaction product of a reaction mixture comprising a polyester, a ring-fused anhydride, and an epoxy. The compositions may comprise a sag control agent. Also disclosed are methods of coating a substrate comprising contacting a surface of the substrate with one of the compositions and substrates comprising a coating on a surface thereof, wherein the coating, in an at least partially cured state, has: an impact resistance at 23° C. and/or at −40° C. of greater than 10 N/mm measured according to ISO 11343 using 0.8 mm thick CRS: a lap shear strength of greater than 12 MPa measured according to ASTM D1002 using 0.8 mm thick hot-dip galvanized steel: and/or a T-peel strength at room temperature of at least 4 N/mm measured according to ASTM D1876 using 0.8 mm thick hot-dip galvanized steel.

### FIELD

The present disclosure relates to compositions, for example adhesive compositions, and to coatings and adhesives.

### BACKGROUND

Coating compositions, including adhesives, are utilized in a wide variety of applications to treat a variety of substrates or to bond together two or more substrate materials.

### SUMMARY

Disclosed herein are compositions, comprising: an epoxy-functional polyester comprising a reaction product of a reaction mixture comprising a polyester, a ring-fused anhydride, and an epoxy; elastomeric particles; and an accelerator.

Also disclosed are methods of coating a substrate comprising: contacting at least a portion of a surface of the substrate with a composition disclosed herein.

Also disclosed are substrates comprising: a coating on a surface, wherein the coating, in an at least partially cured state, has: (a) an impact resistance at 23° C. of greater than 10 N/mm measured according to ISO 11343 using 0.8 mm thick cold rolled steel; (b) an impact resistance at −40° C. of greater than 10 N/mm measured according to ISO 11343 using 0.8 mm thick cold-rolled steel; (c) a lap shear strength of greater than 12 MPa measured according to ASTM D1002 using 0.8 mm thick hot-dip galvanized steel; and/or (d) a T-peel strength of at least 4 N/mm measured according to ASTM D1876 using 0.8 mm thick hot-dip galvanized steel.

Also disclosed are substrates comprising a coating formed from a composition disclosed herein.

Also disclosed are uses of the compositions disclosed herein for making a coating, in an at least partially cured state, a coating on a surface, wherein the coating, in an at least partially cured state, has: (a) an impact resistance at 23° C. of greater than 10 N/mm measured according to ISO 11343 using 0.8 mm thick cold-rolled steel; (b) an impact resistance at −40° C. of greater than 10 N/mm measured according to ISO 11343 using 0.8 mm thick cold rolled steel; (c) a lap shear strength of greater than 12 MPa measured according to ASTM D1002 using 0.8 mm thick hot-dip galvanized steel; and/or (d) a T-peel strength of at least 4 N/mm measured according to ASTM D1876 using 0.8 mm thick hot-dip galvanized steel.

Also disclosed are uses of a coating formed from a composition disclosed herein to provide a substrate having (a) an impact resistance at 23° C. of greater than 10 N/mm measured according to ISO 11343 using 0.8 mm thick cold-rolled steel; (b) an impact resistance at −40° C. of greater than 10 N/mm measured according to ISO 11343 using 0.8 mm thick cold rolled steel; (c) a lap shear strength of greater than 12 MPa measured according to ASTM D1002 using 0.8 mm thick hot-dip galvanized steel; and/or (d) a T-peel strength of at least 4 N/mm measured according to ASTM D1876 using 0.8 mm thick hot-dip galvanized steel.

### BRIEF DESCRIPTION OF THE FIGURES

FIG. 1 is a schematic of the set up that is used for testing the sag of compositions disclosed herein.

### DETAILED DESCRIPTION

For purposes of the following detailed description, it is to be understood that the disclosed subject matter may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about.” even if the term does not expressly appear. Accordingly, unless indicated to the contrary, the numerical parameters set forth in the following specification and attached claims are approximations that may vary depending upon the desired properties to be obtained by the disclosed subject matter. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the disclosed subject matter are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “an” accelerator and “a” polyester, a combination (i.e., a plurality) of these components can be used.

In addition, in this application, the use of “or” means “and/or” unless specifically stated otherwise, even though “and/or” may be explicitly used in certain instances.

As used herein, “including.” “containing.” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described.

As used herein, the terms “on,” “onto,” “applied on,” “applied onto,” “formed on.” “deposited on.” “deposited onto,” mean formed, overlaid, deposited, or provided on but not necessarily in contact with the surface. For example, a coating composition “applied onto” a substrate does not preclude the presence of one or more other intervening coating layers of the same or different composition located between the coating composition and the substrate.

As used herein, a “coating composition” refers to a composition, e.g., a solution, mixture, or a dispersion, that, in an at least partially dried or cured state, is capable of producing a film, layer, or the like on at least a portion of a substrate surface.

As used herein, the term “structural adhesive” means an adhesive producing a load-bearing joint having an impact resistance of greater than 10 N/mm at 23° C. measured according to ISO 11343 using 0.8 mm thick cold rolled steel.

As defined herein, a “1K” or “one-component” coating composition, is a composition in which all of the ingredients may be premixed and stored and wherein the reactive components do not readily react at ambient or slightly thermal conditions, but instead react only upon activation by an external energy source. In the absence of activation from the external energy source, the composition will remain largely unreacted (maintaining sufficient workability in the uncured state and greater than 70% of the initial lap shear strength of the composition in the cured state after storage at 25° C. for 6 months). External energy sources that may be used to promote the curing reaction (i.e., the crosslinking of the epoxy component and the curing agent) include, for example, radiation (i.e., actinic radiation) and/or heat.

As further defined herein, ambient conditions generally refer to room temperature and humidity conditions or temperature and humidity conditions that are typically found in the area in which the adhesive is being applied to a substrate, e.g., at 10° C. to 40° C. and 5% to 80% relative humidity, while slightly thermal conditions are temperatures that are slightly above ambient temperature but are generally below the curing temperature for the coating composition (i.e., in other words, at temperatures and humidity conditions below which the reactive components will readily react and cure, e.g., >40° C. and less than 100° C. at 5% to 80% relative humidity).

As used herein, the “epoxide equivalent weight” may be determined by titration of a sample using a Metrohm 808 or 888 Titrando, using a sample 0.06 g per 100 g/eq of predicted epoxy equivalent weight and dissolving the sample in 20 mL of methylene chloride or tetrahydrofuran and then adding 40 mL glacial acetic acid and one gram of tetraethylammonium bromide before titration with 0.1 N perchloric acid in glacial acetic acid.

As used herein, the “hydroxide equivalent weight” is determined by dividing the theoretical molecular weight of the polyester by the average number of hydroxyl groups present in the polyester.

As used herein, “Mw” refers to the weight average molecular weight and means the theoretical value as determined by Gel Permeation Chromatography using Waters 2695 separation module with a Waters 410 differential refractometer (RI detector), using polystyrene standards, tetrahydrofuran (THF) as the eluent at a flow rate of 1 ml min⁻¹, and two PL Gel Mixed C columns for separation.

As used herein, the term “cure,” “cured,” or similar terms, means that the reactive functional groups of the components that form the composition react to form a film, layer, or bond. As used herein, the term “at least partially cured” means that at least a portion of the components that form the composition interact, react, and/or are crosslinked to form a film, layer, or bond. As used herein, “curing” of the curable composition refers to subjecting said composition to curing conditions leading to reaction of the reactive functional groups of the components of the composition and resulting in the crosslinking of the components of the composition and formation of an at least partially cured film, layer, or bond. As used herein, a “curable” composition refers to a composition that may be cured. In the case of a 1K composition, the composition is at least partially cured or cured when the composition is subjected to curing conditions that lead to the reaction of the reactive functional groups of the components of the composition, such as exposure to moisture or water. A curable composition is at least partially cured or cured when the composition is subjected to curing conditions that lead to the reaction of the reactive functional groups of the components of the composition.

As used herein, the term “accelerator” means a substance that increases the rate or decreases the activation energy of a chemical reaction in comparison to the same reaction in the absence of the accelerator. An accelerator may be either a “catalyst,” that is, without itself undergoing any permanent chemical change, or may be reactive, that is, capable of chemical reactions and includes any level of reaction from partial to complete reaction of a reactant.

As used herein, the terms “latent” or “blocked” or “encapsulated”, when used with respect to an accelerator, means a molecule or a compound that is activated by an external energy source prior to reacting (i.e., crosslinking) or having a catalytic effect, as the case may be. For example, an accelerator may be in the form of a solid at room temperature and have no catalytic effect until it is heated and melts, or the latent accelerator may be reversibly reacted with a second compound that prevents any catalytic effect until the reversible reaction is reversed by the application of heat and the second compound is removed, freeing the accelerator to catalyze reactions, or the latent accelerator may be encapsulated within a thermoplastic material which melts upon heating, releasing the accelerator to catalyze reactions.

As used herein, unless indicated otherwise, the term “substantially free” means that a particular material is not purposefully added to a mixture or composition, respectively, and is present only as an impurity in a trace amount of less than 5 percent by weight based on a total weight of the mixture or composition, respectively. As used herein, unless indicated otherwise, the term “essentially free” means that a particular material is present only in an amount of less than 2 percent by weight based on a total weight of the mixture or composition, respectively. As used herein, unless indicated otherwise, the term “completely free” means that a mixture or composition, respectively, does not comprise a particular material, i.e., the mixture or composition comprises 0 percent by weight of such material.

As used herein, the term “D98” means the point in the size distribution in which 98 percent or more of the total volume of material in the sample is contained. For example, a D98 of 40 μm means that 98 percent of the particles of the sample have a size of 40 μm or smaller as measured by dynamic light scattering.

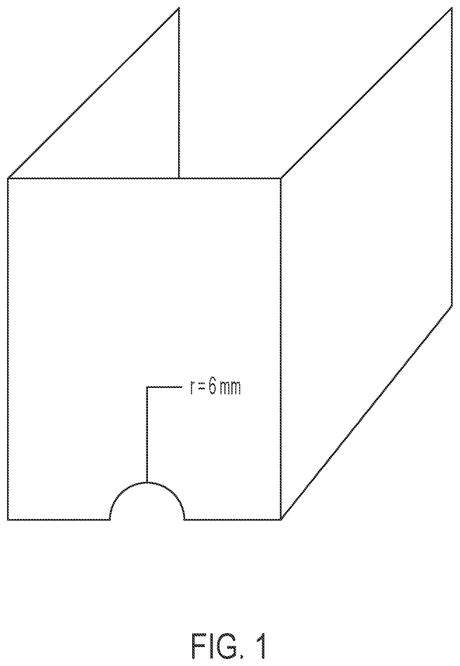

As used herein, the term “sag” means the downward movement, curvature, or flow of a composition as tested according to SAE J243 ADS-9 (Test Method B) modified using the setup shown in FIG. 1.

As used herein, the term “sag control agent” means an agent that reduces sag to 5 mm or less.

The present disclosure is directed to a composition comprising, or consisting essentially of, or consisting of, an epoxy-functional polyester, elastomeric particles, and an accelerator. The composition may be a coating composition, such as an adhesive composition which, in an at least partially cured state, may form a coating such as an adhesive, such as a structural adhesive.

### Epoxy-Functional Polyester

The epoxy-functional polyester may comprise, or consist essentially of, or consist of, a reaction product of a reaction mixture comprising, or consisting essentially of, or consisting of, reactants comprising, or consisting essentially of, or consisting of, an epoxy compound, a polyester, and a ring-fused anhydride. The reaction product may comprise the residue of the epoxy compound.

Useful epoxy compounds that can be used to form the epoxy-functional polyester include polyepoxides (having an epoxy functionality of more than 1).

Suitable polyepoxides include polyglycidyl ethers of Bisphenol A, such as Epon® 828 and 1001 epoxy resins, and polyglycidyl ethers of Bisphenol F diepoxides, such as Epon 862, which are commercially available from Hexion Specialty Chemicals, Inc. Other useful polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, and epoxy novolac resins. Still other non-limiting epoxy compounds include epoxidized Bisphenol A novolacs, epoxidized phenolic novolacs, epoxidized cresylic novolac, isosorbide diglycidyl ether, 1,4-butanediol diglycidyl ether, 1,6-hexanediol diglycidyl ether, triglycidyl p-aminophenol, and triglycidyl p-aminophenol bismaleimide, triglycidyl isocyanurate, tetraglycidyl 4,4′-diaminodiphenylmethane, and tetraglycidyl 4,4′-diaminodiphenylsulphone, and epoxy resins such as Araldite (available from Huntsman) and D.E.R. (available from Olin).

The polyepoxide may have an average epoxide functionality of greater than 1.0, such as at least 1.8, and may have an average epoxide functionality of less than 5.0, such as no more than 3.2, such as no more than 2.8. The polyepoxide may have an average epoxide functionality of greater than 1.0 to less than 5.0, such as 1.8 to 3.2, such as 1.8 to 2.8. As used herein, the term “average epoxide functionality” means the molar ratio of epoxide functional groups to epoxide-containing molecules used as reactants to make the epoxy-functional polyester.

The epoxy compound may have an epoxide equivalent weight of at least 90 g/eq, such as at least 150 g/eq, and may have an epoxide equivalent weight of no more than 400 g/eq, such as no more than 350 g/eq. The epoxy compound may have an epoxide equivalent weight of 90 g/eq to 400 g/eq, such as 150 g/eq to 350 g/eq.

The polyester used to form the epoxy-functional polyester may include hydroxyl-terminated polyesters.

Useful hydroxyl-terminated polyesters include diols, triols, tetraols and higher functional polyols. Combinations of such polyols may also be used. The polyol may also be based on a polyester chain derived from ring opening polymerization of caprolactone (referred to as polycaprolactone-based polyols or a hydroxyl functional polycaprolactone hereinafter). The polycaprolactone-based polyols may comprise diols, triols or tetraols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101.

The polyester may have an average hydroxyl functionality of greater than 1, such as at least 2, and may have an average hydroxyl functionality of less than 8, such as no more than 6, such as no more than 4. The polyester may have an average hydroxide functionality of 2 to less than 8, such as 2 to 6, such as 2 to 4. As used herein, the term “average hydroxyl functionality” means the molar ratio of hydroxyl functional groups to hydroxyl-containing molecules used as reactants to make the epoxy-functional polyester.

The polyester compound may have a hydroxide equivalent weight of at least 125 g/eq, such as at least 275 g/eq, and may have a hydroxide equivalent weight of no more than 1250 g/eq, such as no more than 1000 g/eq. The polyester compound may have a hydroxide equivalent weight of 125 g/eq to 1250 g/eq, such as 275 g/eq to 1000 g/eq.

A ring-fused anhydride may be used to form the epoxy-functional polyester. As used herein, “ring-fused anhydride” refers to any cyclic anhydride having two carbon atoms in common with a cyclic ring that is not an anhydride.

Exemplary structures of ring-fused anhydrides include those having five- or six-membered cyclic anhydrides such as those having more than 4 carbons in the ring other than the anhydride ring and at least one anhydride functional group, such as, for example, the following:

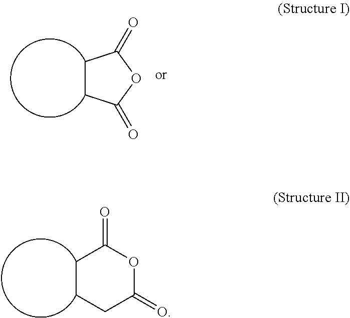 [SMILES: O=C1CCC(=O)O1 ; O=C1CCCC(=O)O1]

Specific examples of ring-fused cyclic anhydrides include:

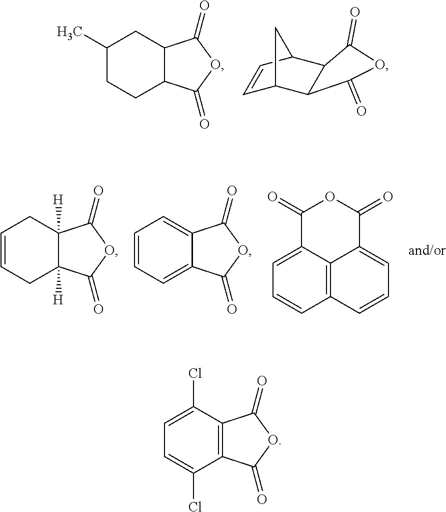

Useful ring-fused anhydrides include phthalic anhydrides and/or carboxylic anhydrides. For example, the ring-fused anhydride may include phthalic anhydride, hexahydro-4-methyl-phthalic anhydride, tetrahydrophthalic anhydride, cis-5-noreborene-endo-2,3-dicarboxylic acid anhydride, 3,4,5,6-Tetrahydrophthalic anhydride, 3,4-Pyridinedicarboxylic anhydride, 3,6-Dichlorophthalic anhydride, 3,3-Tetramethyleneglutaric anhydride, 1,8-Naphthalic anhydride, 4,4′-(4,4′-Isopropylidenediphenoxy)bis(phthalic anhydride), 4,4′-Oxydiphthalic anhydride, or combinations thereof.

The composition may be substantially free, or essentially free, or completely free, of anhydrides that are not ring-fused, such as succinic anhydride or maleic anhydride.

The ring-fused anhydride may have an Mw of at least 100 g/mol, such as at least 200 g/mol, and may have an Mw of no more than 600 g/mol, such as no more than 500 g/mol. The ring-fused anhydride may have an Mw of 100 g/mol to 600 g/mol, such as 200 g/mol to 500 g/mol.

The ring-fused anhydride may have at least one anhydride functional group, such as at least two anhydride functional groups.

The equivalent ratio of epoxide groups to hydroxyl groups to anhydride groups may be 20:1:0.5 to 2:2:1, such as 10:0.8:1 to 3:1:1, such as 6:1:1 to 4:1:1.

The epoxy-functional polyester may be present in the composition in an amount of at least 5 percent by weight based on total weight of the composition, such as at least 7 percent by weight, and may be present in the composition in an amount of no more than 40 percent by weight based on total weight of the composition, such as no more than 30 percent by weight. The epoxy-functional polyester may be present in the composition in an amount of 5 percent by weight to 40 percent by weight based on total weight of the composition, such as 7 percent by weight to 30 percent by weight.

The epoxy-functional polyester may have an epoxide equivalent weight of at least 150 g/eq, such as at least 200 g/eq, and may have an epoxide equivalent weight of no more than 1500 g/eq, such as no more than 1000 g/eq. The epoxy-functional polyester may have an epoxide equivalent weight of 150 g/eq to 1500 g/eq, such as 200 g/eq to 1000 g/eq.

The epoxy-functional polyester may have an Mw of at least 800 g/mol, such as at least 2,000 g/mol, and may have an Mw of no more than 100,000 g/mol, such as no more than 60,000 g/mol. The epoxy-functional polyester may have an Mn of 800 g/mol to 100,000 g/mol, such as 2,000 g/mol to 60,000 g/mol.

### Elastomeric Particles

The composition may further comprise elastomeric particles. As used herein, “elastomeric particles” refers to particles comprised of one or more materials having at least one glass transition temperature (Tg) of greater than −150° C. and less than 30° C., calculated, for example, using the Fox Equation. As used herein, the term “glass transition temperature” (“Tg”) refers to the temperature at which an amorphous material, such as glass or a polymer, changes from a brittle vitreous state to a plastic state or from a plastic state to a brittle vitreous state.

The elastomeric particles may be phase-separated from an epoxy-containing component. As used herein, the term “phase-separated” means forming a discrete domain within a matrix of the epoxy-containing component.

The elastomeric particles may have a core/shell structure. Suitable core-shell elastomeric particles may be comprised of an acrylic shell and an elastomeric core. The core may comprise natural or synthetic rubbers, polybutadiene, styrene-butadiene, polyisoprene, chloroprene, acrylonitrile butadiene, butyl rubber, polysiloxane, polysulfide, ethylene-vinyl acetate, fluoroelastomer, polyolefin, or combinations thereof. The elastomeric particles e.g. may comprise a polybutadiene core, a styrene butadiene core, and/or a polysiloxane core.

According to the present disclosure, the average particle size of the elastomeric particles may be at least 20 nm, as measured by transmission electron microscopy (TEM), such as at least 30 nm, such as at least 40 nm, such as at least 50 nm, and may be no more than 400 nm, such as no more than 300 nm, such as no more than 200 nm, such as no more than 150 nm. According to the present disclosure, the average particle size of the elastomeric particles may be 20 nm to 400 nm as measured by TEM, such as 30 nm, to 300 nm, such as 40 nm to 200 nm, such as 50 nm to 150 nm. Suitable methods of measuring particle sizes by TEM include suspending elastomeric particles in a solvent selected such that the particles do not swell, and then drop casting the suspension onto a TEM grid which is allowed to dry under ambient conditions. For example, epoxy resin containing core-shell rubber elastomeric particles from Kaneka Texas Corporation can be diluted in butyl acetate for drop casting. Particle size measurements may be obtained from images acquired using a Tecnai T20 TEM operating at 200 kV and analyzed using ImageJ software, or an equivalent instrument and software.

According to the present disclosure, the elastomeric particles may optionally be included in an epoxy carrier resin for introduction into the coating composition. Suitable finely dispersed core-shell elastomeric particles in an average particle size ranging from 20 nm to 400 nm may be master-batched in epoxy resin such as aromatic epoxides, phenolic novolac epoxy resin, bisphenol A and/or bisphenol F diepoxide, and/or aliphatic epoxides, which include cyclo-aliphatic epoxides, at concentrations ranging from 1% to 80% core-shell elastomeric particles by weight based on the total weight of the elastomeric dispersion, such as from 5% to 50%, such as from 15% to 35%. Suitable epoxy resins may also include a mixture of epoxy resins. When utilized, the epoxy carrier resin may be an epoxy-containing component of the present disclosure such that the weight of the epoxy-containing component present in the coating composition includes the weight of the epoxy carrier resin.

Exemplary non-limiting commercial core-shell elastomeric particle products using poly(butadiene) rubber particles that may be utilized in the coating composition of the present disclosure include core-shell poly(butadiene) rubber powder (commercially available as PARALOID™ EXL 2650A from Dow Chemical), a core-shell poly(butadiene) rubber dispersion (25% core-shell rubber by weight) in bisphenol F diglycidyl ether (commercially available as Kane Ace MX 136), a core-shell poly(butadiene) rubber dispersion (33% core-shell rubber by weight) in Epon® 828 (commercially available as Kane Ace MX 153), a core-shell poly(butadiene) rubber dispersion (33% core-shell rubber by weight) in Epiclon® EXA-835LV (commercially available as Kane Ace MX 139), a core-shell poly(butadiene) rubber dispersion (37% core-shell rubber by weight) in bisphenol A diglycidyl ether (commercially available as Kane Ace MX 257), and a core-shell poly(butadiene) rubber dispersion (37% core-shell rubber by weight) in Epon® 863 (commercially available as Kane Ace MX 267), each available from Kancka Texas Corporation.

Exemplary non-limiting commercial core-shell elastomeric particle products using styrene-butadiene rubber particles that may be utilized in the coating composition include a core-shell styrene-butadiene rubber powder (commercially available as CLEARSTRENGTH® XT100 from Arkema), an MMA-Styrene-Butadiene core shell rubber (commercially available as Clearstrength XT 100 from Arkema), a core-shell styrene-butadiene rubber powder (commercially available as PARALOID™ EXL 2650J), a core-shell styrene-butadiene rubber dispersion (33% core-shell rubber by weight) in bisphenol A diglycidyl ether (commercially available as Fortegra™ 352 from Olin™), a core-shell styrene-butadiene rubber dispersion (33% rubber by weight) in low viscosity bisphenol A diglycidyl ether (commercially available as Kane Ace MX 113), a core-shell styrene-butadiene rubber dispersion (25% core-shell rubber by weight) in bisphenol A diglycidyl ether (commercially available as Kane Ace MX 125), a core-shell styrene-butadiene rubber dispersion (25% core-shell rubber by weight) in bisphenol F diglycidyl ether (commercially available as Kane Ace MX 135), a core-shell styrene-butadiene rubber dispersion (25% core-shell rubber by weight) in D.E.N.™-438 phenolic novolac epoxy (commercially available as Kane Ace MX 215), a core-shell styrene-butadiene rubber dispersed in bisphenol A epoxy resin (such as KDAD-7101 35% core shell rubber by weight) (commercially available from Kukdo Chemical), a core-shell styrene-butadiene rubber dispersion (25% core-shell rubber by weight) in Araldite® MY-721 multi-functional epoxy (commercially available as Kane Ace MX 416), a core-shell styrene-butadiene rubber dispersion (25% core-shell rubber by weight) in MY-0510 multi-functional epoxy (commercially available as Kane Ace MX 451), a core-shell styrene-butadiene rubber dispersion (25% core-shell rubber by weight) in Syna Epoxy 21 Cyclo-aliphatic Epoxy from Synasia (commercially available as Kane Ace MX 551), and a core-shell styrene-butadiene rubber dispersion (25% core-shell rubber by weight) in polypropylene glycol (MW 400) (commercially available as Kane Ace MX 715), each available from Kaneka Texas Corporation.

Exemplary non-limiting commercial core-shell elastomeric particle products using polysiloxane rubber particles that may be utilized in the coating composition of the present disclosure include a core-shell polysiloxane rubber powder (commercially available as GENIOPERL® P52 from Wacker), a core-shell polysiloxane rubber dispersion (40% core-shell rubber by weight) in bisphenol A diglycidyl ether (commercially available as ALBIDUR® EP2240A from Evonick), a core-shell polysiloxane rubber dispersion (25% core-shell rubber by weight) in Epon 828 (commercially available as Kane Ace MX 960), a core-shell polysiloxane rubber dispersion (25% core-shell rubber by weight) in Epon® 863 (commercially available as Kane Ace MX 965) each available from Kancka Texas Corporation.

The elastomeric particles may be present in the composition in an amount of at least 7 percent by weight based on the total weight of the composition, such as at least 9 percent by weight, such as at least 15 percent by weight, and in some cases may be present in the composition in an amount of no more than 80 percent by weight based on the total composition weight, such as no more than 70 percent by weight, such as no more than 30 percent by weight. According to the present disclosure, the elastomeric particles may be present in the composition in an amount of 7 percent by weight to 80 percent by weight based on the total composition weight, such as 9 percent by weight to 70 percent by weight, such as 15 percent to 30 percent.

According to the present disclosure, at least 50 percent by weight of the elastomeric particles have an average particle size (based on TEM as described herein) of no more than 150 nm based on total weight of the elastomeric particles in the coating composition, such as 20 nm to 150 nm. For example, elastomeric particles having an average particle size (based on TEM as described herein) of no more than 150 nm, such as 20 nm to 150 nm, may be present in the coating composition in an amount of at least 50 percent by weight based on total weight of the elastomeric particles, such as at least 65 percent by weight, such as at least 80 percent by weight, and may be present in an amount of 100 percent by weight based on total weight of elastomeric particles in the coating composition, such as no more 99 percent by weight, such as no more than 98 percent by weight. Elastomeric particles having an average particle size of no more than 150 nm (based on TEM as described herein), such as 20 nm to 150 nm, may be present in the coating composition in an amount of 50 percent by weight to 100 percent by weight based on total weight of the elastomeric particles in the coating composition, such as 65 percent by weight to 99 percent by weight, such as 80 percent by weight to 98 percent by weight.

### Accelerator

The composition of the present disclosure further comprises an accelerator. The accelerator may be latent, such as a blocked and/or an encapsulated accelerator.

For example, the accelerator may be an amine-based catalyst. For example, the accelerator may be a guanidine, a substituted guanidine, a substituted urea, a melamine resin, a guanamine derivative, a cyclic tertiary amine, an aromatic amine, or combinations thereof. It will be understood that “guanidine,” as used herein, refers to guanidine and derivatives thereof.

Useful accelerators include as trimethylamine; tributylamine; N,N-bis(N,N-dimethyl-2-aminoethyl)methylamine; N,N-dimethylcyclohexylamine; N-methylmorpholine; N-ethylmorpholine; piperidine; piperazine; pyrrolidine; homopiperazine; 1,2-dimethyl-1,4,5,6-tetrahydropyrimidine; 1,4,5,6-tetrahydropyrimidine; 1,8-diazabicyclo[5.4.0]undec-7-ene; 1,5,7-triazabicyclo[4.4.0]dec-5-ene; 7-methyl-1,5,7-triazabicyclo[4.4.0]dec-5-ene; 1,5-diazabicyclo[4.3.0]non-5-ene; 6-(dibutylamino)-1,8-diazabicyclo(5,4,0)undec-7-ene; 1,4-diazabicyclo[2.2.2]octane; 7-azabicyclo[2.2.1]heptane; N, N-dimethylphenylamine; 4,5-dihydro-1H-imidazole; and guanidine-based catalysts such as guanidine, methylguanidinc, dimethylguanidine, trimethylguanidine, tetramethylguanidine, pentamethylguanidine, methylisobiguanidine, dimethylisobiguanidine, tetramethylisobiguanidine, hexamethylisobiguanidine, heptamethylisobiguanidine, phenylguanidine, diphenylguanidine, butylbiguanide, 1-o-tolylbiguanide, 1-phenylbiguanide, 1-methyl-3-nitroguanidine, 1,8-bis(tetramethylguanidino)-naphthalene, and N,N,N′,N′-tetramethyl-N″-[4-morpholinyl(phenylimino)methyl]guanidine. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, more especially, cyanoguanidine (dicyandiamide, e.g., Dyhard® available from AlzChem). Representatives of suitable guanamine derivatives which may be mentioned are alkylated benzoguanamine resins, benzoguanamine resins or methoxymethylethoxymethylbenzoguanamine.

The accelerator may comprise azoles, diazoles, triazoles, higher functional azoles, and combinations thereof. Suitable alkaloid compounds include pyrrolidine, tropane, pyrrolizidine, piperidine, quinolizidine, indolizidine, pyridine, isoquinoline, oxazole, isoxazole, thiazole, quinazoline, acridine, quinoline, indole, imidazole, purine, phenethylamine, muscarine, benzylamines, derivatives of these alkaloid compounds, or combinations thereof, e.g., the accelerator may comprise a guanidine, a guanidine derivative and/or an imidazole.

For example, the guanidine may comprise a compound, moiety, and/or residue having the following general structure:

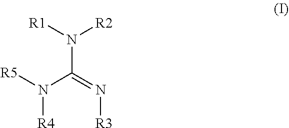

wherein each of R1, R2, R3, R4, and R5 (i.e., substituents of structure (I)) comprise hydrogen, (cyclo)alkyl, aryl, aromatic, organometallic, a polymeric structure, or together can form a cycloalkyl, aryl, or an aromatic structure, and wherein R1, R2, R3, R4, and R5 may be the same or different. As used herein, “(cyclo)alkyl” refers to both alkyl and cycloalkyl. When any of the R groups “together can form a (cyclo)alkyl, aryl, and/or aromatic group”, it is meant that any two adjacent R groups are connected to form a cyclic moiety, such as the rings in structures (II)-(V) below.

It will be appreciated that the double bond between the carbon atom and the nitrogen atom that is depicted in structure (I) may be located between the carbon atom and another nitrogen atom of structure (I). Accordingly, the various substituents of structure (I) may be attached to different nitrogen atoms depending on where the double bond is located within the structure.

The guanidine may comprise a cyclic guanidine such as a guanidine of structure (I) wherein two or more R groups of structure (I) together form one or more rings. In other words, the cyclic guanidine may comprise ≥1 ring(s). For example, the cyclic guanidine may either be a monocyclic guanidine (1 ring) such as depicted in structures (II) and (III) below, or the cyclic guanidine may be bicyclic or polycyclic guanidine (≥2 rings) such as depicted in structures (IV) and (V) below.

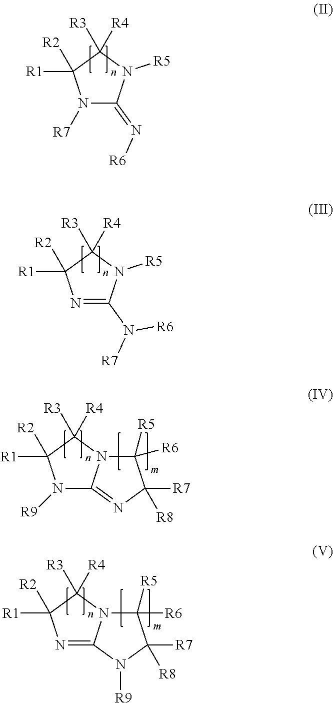

Each substituent of structures (II) and/or (III), R1-R7, may comprise hydrogen, (cyclo)alkyl, aryl, aromatic, organometallic, a polymeric structure, or together can form a cycloalkyl, aryl, or an aromatic structure, and wherein R1-R7 may be the same or different. Similarly, each substituent of structures (IV) and (V), R1-R9, may be hydrogen, alkyl, aryl, aromatic, organometallic, a polymeric structure, or together can form a cycloalkyl, aryl, or an aromatic structure, and wherein R1-R9 may be the same or different. Moreover, in some examples of structures (II) and/or (III), certain combinations of R1-R7 may be part of the same ring structure. For example, R1 and R7 of structure (II) may form part of a single ring structure. Moreover, it will be understood that any combination of substituents (R1-R7 of structures (II) and/or (III) as well as R1-R9 of structures (IV) and/or (V)) may be chosen so long as the substituents do not substantially interfere with the catalytic activity of the cyclic guanidine.

Each ring in the cyclic guanidine may be comprised of ≥5 members. For example, the cyclic guanidine may comprise a 5-member ring, a 6-member ring, and/or a 7-member ring. As used herein, the term “member” refers to an atom located in a ring structure. Accordingly, a 5-member ring will have 5 atoms in the ring structure (“n” and/or “m”=1 in structures (II)-(V)), a 6-member ring will have 6 atoms in the ring structure (“n” and/or “m”=2 in structures (II)-(V)), and a 7-member ring will have 7 atoms in the ring structure (“n” and/or “m”=3 in structures (II)-(V)). It will be appreciated that if the cyclic guanidine is comprised of ≥2 rings (e.g., structures (IV) and (V)), the number of members in each ring of the cyclic guanidine can either be the same or different. For example, one ring may be a 5-member ring while the other ring may be a 6-member ring. If the cyclic guanidine is comprised of ≥3 rings, then in addition to the combinations cited in the preceding sentence, the number of members in a first ring of the cyclic guanidine may be different from the number of members in any other ring of the cyclic guanidine.

It will also be understood that the nitrogen atoms of structures (II)-(V) may further have additional atoms attached thereto. Moreover, the cyclic guanidine may either be substituted or unsubstituted. For example, as used herein in conjunction with the cyclic guanidine, the term “substituted” refers to a cyclic guanidine wherein R5, R6, and/or R7 of structures (II) and/or (III) and/or R9 of structures (IV) and/or (V) is not hydrogen. As used herein in conjunction with the cyclic guanidine, the term “unsubstituted” refers to a cyclic guanidine wherein R1-R7 of structures (II) and/or (III) and/or R1-R9 of structures (IV) and/or (V) are hydrogen.

The cyclic guanidine may comprise a bicyclic guanidine, and the bicyclic guanidine may comprise 1,5,7-triazabicyclo[4.4.0]dec-5-ene (“TBD” or “BCG”).

The guanidine particles may have a D98 particle size of 40 μm as measured by dynamic light scattering, such as a D98 particle size of 20 μm, such as a D98 particle size of 15 μm. Instruments useful for measuring the D98 include a LS 13 320 Laser Diffraction Particle Size Analyzer (available from Beckman Coulter) or similar instruments.

In other examples, the accelerator may comprise amidoamine or polyamide catalysts, such as, for example, one of the Ancamide® products available from Air Products, amine (such as DY9577 boron complex, ARDUR HT 973, and ARDUR 1167 available from Huntsman Advanced Materials), dihydrazide, or dicyandiamide adducts and complexes, such as, for example, one of the Ajicure® products available from Ajinomoto Fine Techno Company, 3,4-dichlorophenyl-N,N-dimethylurea (A.K.A. Diuron) available from Alz Chem, or combinations thereof.

The accelerator may be present in the composition in an amount of at least 1 percent by weight based on total weight of the composition, such as at least 3 percent by weight, and may be present in an amount of no more than 15 percent by weight based on total weight of the composition, such as no more than 13 percent by weight. The guanidine may be present in the composition in an amount of 1 percent by weight to 15 percent by weight based on total weight of the composition, such as 3 percent by weight to 13 percent by weight.

### Epoxy-Containing Compounds

The composition optionally may further comprise an epoxy-containing compound that is different than the epoxy-functional polyester described above. The epoxy-containing compound may comprise a copolymer of an epoxy compound and a diol.

Useful epoxy compounds that can be used to form the epoxy-containing compound include monoepoxides and/or polyepoxides. Suitable monoepoxides that may be used include monoglycidyl ethers of alcohols and phenols, such as phenyl glycidyl ether, n-butyl glycidyl ether, cresyl glycidyl ether, isopropyl glycidyl ether, glycidyl versatate, for example, CARDURA E available from Shell Chemical Co., and glycidyl esters of monocarboxylic acids such as glycidyl neodecanoate, and mixtures of any of the foregoing. Suitable polyepoxides include polyglycidyl ethers of Bisphenol A, such as Epon® 828 and 1001 epoxy resins, and polyglycidyl ethers of Bisphenol F diepoxides, such as Epon® 862, which are commercially available from Hexion Specialty Chemicals, Inc. Other suitable polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides that are derived from the epoxidation of an olefinically unsaturated nonaromatic cyclic compound, polyepoxides containing oxyalkylene groups in the epoxy molecule, and epoxy novolac resins. Still other suitable epoxy-containing compounds include epoxidized Bisphenol A novolacs, epoxidized phenolic novolacs, and epoxidized cresylic novolac. The epoxy-containing compound may also comprise an epoxy-dimer acid adduct. The epoxy-dimer acid adduct may be formed as the reaction product of reactants comprising a diepoxide compound (such as a polyglycidyl ether of Bisphenol A) and a dimer acid (such as a C36 dimer acid), isosorbide diglycidyl ether, and triglycidyl isocyanurate. The epoxy-containing compound may also comprise a carboxyl-terminated butadiene-acrylonitrile copolymer modified epoxy-containing compound. The epoxy-containing compound may also comprise an epoxy-containing acrylic, such as glycidyl methacrylate.

The epoxy-containing compound may comprise an epoxy-adduct. The composition may comprise one or more epoxy-adducts. As used herein, the term “epoxy-adduct” refers to a reaction product comprising the residue of an epoxy compound and at least one other compound that does not include an epoxide functional group. For example, the epoxy-adduct may comprise the reaction product of reactants comprising: (1) an epoxy compound, a polyol, and a diacid; and/or (2) an epoxy compound, a polyol, an anhydride, and a diacid.

The epoxy compound used to form the epoxy-adduct may comprise any of the epoxy-containing compounds listed above that may be included in the composition.

The polyol used to form the epoxy-adduct may include diols, triols, tetraols and higher functional polyols. Combinations of such polyols may also be used. The polyols may be based on a polyether chain derived from ethylene glycol, propylene glycol, butylene glycol, hexylene glycol and the like as well as mixtures thereof. Useful diols that may be used to form the epoxy-containing compound include bisphenol A and hexane diols. Suitable polyols may also include polyether polyols, polyurethane polyols, polyurea polyols, acrylic polyols, polyester polyols, polybutadiene polyols, hydrogenated polybutadiene polyols, polycarbonate polyols, polysiloxane polyols, and combinations thereof. Polyamines corresponding to polyols may also be used, and in this case, amides instead of carboxylic esters will be formed with the diacids and anhydrides.

The polyol may comprise a polytetrahydrofuran-based polyol. The polytetrahydrofuran-based polyols may comprise diols, triols or tetraols terminated with primary hydroxyl groups. Commercially available polytetrahydrofuran-based polyols include those sold under the trade name Terathane®, such as Terathane® PTMEG 250 and Terathane® PTMEG 650 which are blends of linear diols in which the hydroxyl groups are separated by repeating tetramethylene ether groups, available from Invista. In addition, polyols based on dimer diols sold under the trade names Pripol®, Solvermol™ and Empol®, available from Cognis Corporation, or bio-based polyols, such as the tetrafunctional polyol Agrol 4.0, available from BioBased Technologies, may also be utilized.

The diacid used to form the epoxy-adduct may comprise any suitable diacid known in the art. For example, the diacids may comprise phthalic acid and its derivates (e.g., methyl phthalic acid), hexahydrophthalic acid and its derivatives (e.g., methyl hexahydrophthalic acid), maleic acid, succinic acid, adipic acid, and the like.

Other suitable epoxy-containing compounds include epoxy-adducts such as polyesters formed as the reaction product of reactants comprising an epoxy-containing compound, a polyol, and an anhydride, as described in U.S. Pat. No. 8,796,361, col. 3, line 42 through col. 4, line 65, the cited portion of which is incorporated herein by reference. For example, useful first epoxy compounds that can be used to form the epoxy-adduct include polyepoxides. Suitable polyepoxides include polyglycidyl ethers of Bisphenol A, such as Epon R 828 and 1001 epoxy resins, and Bisphenol F diepoxides, such as Epon R 862, which are commercially available from Hexion Specialty Chemicals, Inc. Other useful polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, and epoxy novolac resins. Still other non-limiting first epoxy compounds include epoxidized Bisphenol A novolacs, epoxidized phenolic novolacs, epoxidized cresylic novolac, and triglycidyl p-aminophenol bismaleiimide. Useful polyols that may be used to form the epoxy-adduct include diols, triols, tetraols and higher functional polyols. The polyols can be based on a polyether chain derived from ethylene glycol, propylene glycol, butylenes glycol, hexylene glycol and the like and mixtures thereof. The polyol can also be based on a polyester chain derived from ring opening polymerization of caprolactone. Suitable polyols may also include polyether polyol, polyurethane polyol, polyurea polyol, acrylic polyol, polyester polyol, polybutadiene polyol, hydrogenated polybutadiene polyol, polycarbonate polyols, polysiloxane polyol, and combinations thereof. Polyamines corresponding to polyols can also be used, and in this case, amides instead of carboxylic esters will be formed with acids and anhydrides. Suitable diols that may be utilized to form the epoxy adduct are diols having a hydroxyl equivalent weight of between 30 and 1000. Exemplary diols having a hydroxyl equivalent weight from 30 to 1000 include diols sold under the trade name Terathane®, including Terathane R250, available from Invista. Other exemplary diols having a hydroxyl equivalent weight from 30 to 1000 include ethylene glycol and its polyether diols, propylene glycol and its polyether diols, butylenes glycol and its polyether diols, hexylene glycols and its polyether diols, polyester diols synthesized by ring opening polymerization of caprolactone, and urethane diols synthesized by reaction of cyclic carbonates with diamines. Combination of these diols and polyether diols derived from combination various diols described above could also be used. Dimer diols may also be used including those sold under trade names Pripol®) and Solvermol™ available from Cognis Corporation. Polytetrahydrofuran-based polyols sold under the trade name Terathane®, including Terathane® 650, available from Invista, may be used. In addition, polyols based on dimer diols sold under the trade names Pripol® and Empol®, available from Cognis Corporation, or bio-based polyols, such as the tetrafunctional polyol Agrol 4.0, available from BioBased Technologies, may also be utilized. Useful anhydride compounds to functionalize the polyol with acid groups include hexahydrophthalic anhydride and its derivatives (e.g., methyl hexahydrophthalic anhydride); phthalic anhydride and its derivatives (e.g., methyl phthalic anhydride); maleic anhydride. Succinic anhydride; trimelletic anhydride; pyromelletic dianhydride (PMDA); 3.3′,4,4′-oxy diphthalic dianhydride (ODPA); 3,3′,4,4′-benzopherone tetracarboxylic dianhydride (BTDA); and 4,4′-diphthalic (hexamfluoroisopropylidene) anhydride (6FDA). Useful diacid compounds to functionalize the polyol with acid groups include phthalic acid and its derivates (e.g., methyl phthalic acid), hexahydrophthalic acid and its derivatives (e.g., methyl hexahydrophthalic acid), maleic acid, succinic acid, adipic acid, etc. Any diacid and anhydride can be used; however, anhydrides are preferred. In one embodiment, the polyol comprises a diol, the anhydride and/or diacid comprises a monoanhydride or a diacid, and the first epoxy compound comprises a diepoxy compound, wherein the mole ratio of diol, monoanhydride (or diacid), and diepoxy compounds in the epoxy-adduct may vary from 0.5:0.8:1.0 to 0.5:1.0:6.0. In another embodiment, the polyol comprises a diol, the anhydride and/or diacid comprises a monoanhydride or a diacid, and the first epoxy compound comprises a diepoxy compound, wherein the mole ratio of diol, monoanhydride (or a diacid), and diepoxy compounds in the epoxy-adduct may vary from 0.5:08:0.6 to 0.5:1.0:6.0.

The epoxy-containing compound may be present in an amount of at least 0.5 percent by weight based on total weight of the composition, such as at least 1 percent by weight. such as at least 2 percent by weight and may be present in an amount of no more than 30 percent by weight based on total weight of the composition, such as no more than 25 percent by weight, such as no more than 20 percent by weight. The epoxy-containing compound may be present in an amount of 0.5 percent by weight to 30 percent by weight based on total weight of the composition, such as 1 percent by weight to 25 percent by weight, such as 2 percent by weight to 20 percent by weight.

### Fillers

Optionally, the composition may further comprise at least one filler. Useful fillers that may be introduced to provide improved mechanical materials include fiberglass, fibrous titanium dioxide, whisker type calcium carbonate (aragonite), and carbon fiber (which includes graphite and carbon nanotubes). In addition, fiber glass ground to 5 microns or wider and to 50 microns or longer may also provide additional tensile strength. Additionally, the filler optionally may be graphene and graphenic carbon particles for example, xGnP graphene nanoplatelets commercially available from XG Sciences, and/or for example, carbon particles having structures comprising one or more layers of one-atom-thick planar sheets of sp2-bonded carbon atoms that are densely packed in a honeycomb crystal lattice. The average number of stacked layers may be less than 100, for example, less than 50. The average number of stacked layers may be 30 or less, such as 20 or less, such as 10 or less, such as 5 or less. The graphenic carbon particles may be substantially flat; however, at least a portion of the planar sheets may be substantially curved, curled, creased, or buckled. The particles typically do not have a spheroidal or equiaxed morphology. Suitable graphenic carbon particles are described in U.S. Publication No. 2012/0129980, at paragraphs [0059]-[0065], the cited portion of which is incorporated herein by reference. Other suitable graphenic carbon particles are described in U.S. Pat. No. 9,562,175, at col. 6, line 6 to col. 9, line 52, the cited portion of which is incorporated herein by reference. Suitable carbon nanotubes may be multi-walled or single-walled carbon nanotubes or pre-dispersions thereof such as Tuball™ Matrix 301.

Useful organic fillers that may be introduced include cellulose, starch, and acrylic. Useful inorganic fillers that may be introduced include borosilicate, aluminosilicate, calcium inosilicate (Wollastonite), mica, silica, zeolite, perlite, and calcium carbonate. The organic and inorganic fillers may be solid, hollow, multicellular, or layered in composition and may range in size from 10 nm to 1 mm in at least one dimension, measured, for example by TEM or SEM. Fillers may be surface treated such as by silane monomers or polysiloxanes.

Such fillers, if present at all, may be present in the composition in an amount of no more than 25 percent by weight based on total weight of the composition, such as no more than 20 percent by weight, such as no more than 15 percent by weight. Such fillers may be present in the composition an amount of 0.1 percent by weight to 25 percent by weight based on total weight of the composition, such as 1 percent by weight to 20 percent by weight, such as 2 percent by weight to 15 percent by weight.

Optionally, the composition may be substantially free, or essentially free, or completely free, of platy fillers such as talc, pyrophyllite, chlorite, vermiculite, or combinations thereof.

### Additives

The composition may optionally comprise at least one additive. As used herein, an “additive” refers to a rheology modifier, a tackifier, a surface-active agent, a wetting agent, a flame retardant, a corrosion inhibitor, a UV stabilizer, a colorant, a tint, a solvent, a plasticizer, an adhesion promoter, an antioxidant, a defoamer, an oil, a rust inhibitor, a silane, a silane terminated polymer, a silyl terminated polymer, and/or a moisture scavenger.

Rheology modifiers optionally may include thixotropes. Thixotropes may be sag control agents. Useful thixotropes and/or sag control agents that may be used include wax, fumed silica, castor wax, clay, organo clay, fibers such as Aramid® fibers and Kevlar® fibers, ceramic fibers, and/or engineered cellulose fibers. Waxes useful in the compositions disclosed herein are not particularly limited provided the wax has properties suitable for thixotropy and/or sag control. Generally, the wax may have a weight-average molecular weight of less than 10,000. Examples of suitable waxes useful in the compositions disclosed herein include microcrystalline waxes, polyethylene waxes, Fischer-Tropsch waxes, paraffin waxes, Castor wax, polypropylene waxes, amide derivatives of the former, or combinations thereof. Further examples of suitable thixotropes and/or sag control agents include organic resins or solids comprising chemical linkages with hydrogen bonding capability, such as polyurethane, polyurea, polyester, polyaramid, polyimide, carbodiimide, and combinations thereof. Such polyureas may include those disclosed in U.S. Pat. No. 4,965,317 at col. 5, line 10 to col. 6, line 24, incorporated herein by reference. The organic resins or solids may optionally comprise reactive functional groups such as epoxide, isocyanate, or ethylenic unsaturation. Combinations of thixotropes may be used to achieve sag control. The sag control agents may be present in the composition in a combined amount of at least 1.1 percent by weight based on total weight of the composition, such as at least 1.5 percent by weight, and may be present in the composition in a combined amount of no more than 7 percent by weight based on total weight of the composition, such as no more than 6 percent by weight. The sag control agents may be present in the composition in a combined amount of 1.1 percent by weight to 7 percent by weight based on total weight of the composition, such as 1.5 percent by weight to 6 percent by weight.

Examples of suitable wetting agents include those under the commercial name BYK®, DISPERBYK®, DOWSIL™, TEGO® Wet, and TERGITOL™.

Examples of suitable corrosion inhibitors include, for example, zinc phosphate-based corrosion inhibitors, for example, micronized Halox® SZP-391, Halox® 430 calcium phosphate, Halox® ZP zinc phosphate, Halox® SW-111 strontium phosphosilicate, Halox® 720 mixed metal phosphor-carbonate, and Halox® 550 and 650 proprietary organic corrosion inhibitors commercially available from Halox. Other suitable corrosion inhibitors include Heucophos® ZPA zinc aluminum phosphate and Heucophos® ZMP zinc molybdenum phosphate, commercially available from Heucotech Ltd.

A corrosion inhibitor can comprise a lithium silicate such as lithium orthosilicate (Li₄SiO₄) and lithium metasilicate (Li₂SiO₃), MgO, an azole, or a combination of any of the foregoing. The corrosion inhibiting component may further comprise at least one of magnesium oxide (MgO) and an azole.

Useful colorants or tints may include phthalocyanine blue and ultramarine blue.

Compositions provided by the present disclosure can comprise a flame retardant or combination of flame retardants. Certain thermally conductive materials such as aluminum hydroxide and magnesium hydroxide, for example, also may be flame retardants. As used herein, “flame retardant” refers to a material that slows down or stops the spread of fire or reduces its intensity. Flame retardants may be available as a powder that may be mixed with a composition, a foam, or a gel. In examples, when the compositions disclosed herein include a flame retardant, such compositions may form a coating on a substrate surface and such coating may function as a flame retardant.

As set forth in more detail below, a flame retardant can include a mineral, an organic compound, an organohalogen compound, an organophosphorous compound, or a combination thereof.

Suitable examples of minerals include huntite, hydromagnesite, various hydrates, red phosphorous, boron compounds such as borates, carbonates such as calcium carbonate and magnesium carbonate, and combinations thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Such halogenated flame retardants may be used in conjunction with a synergist to enhance their efficiency. Other suitable examples include antimony trioxide, antimony pentaoxide, and sodium antimonate.

Suitable examples of organophosphorous compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminium diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Suitable examples of organic compounds include carboxylic acid, dicarboxylic acid, melamine, and organonitrogen compounds.

Other suitable flame retardants include ammonium polyphosphate and barium sulfate.

Useful plasticizers that may be used include polymers, trimellitates, sebacates, esters, phthalates, citrates, adipates, benzoates, and the like. Non-limiting examples of such plasticizers include diisononylphthalate (Jayflex™ DINP available from Exxon Mobil), dioctylphthalate (Cereplas DOA™ available from Valtris), diisodecylphthalate (Jayflex™ DIDP available from Exxon Mobil), and alkyl benzyl phthalate (Santicizer 278 available from Valtris); benzoate-based plasticizers such as dipropylene glycol dibenzoate (K-Flex® available from Emerald Performance Materials); and other plasticizers including terephthalate-based dioctyl terephthalate (DEHT available from Eastman Chemical Company), alkylsulfonic acid ester of phenol (Mesamoll available from Borchers), epoxidized soybean oil (Plaschek 775 from Valtris), citric acid esters (Citroflex available from Morflex), phenylphophates (Santicizer 148 from Solutia), and 1,2-cyclohexane dicarboxylic acid diisononyl ester (Hexamoll DINCH available from BASF).

Stabilizers may be blended to prevent reduction of molecular weight by heating. gelation, coloration, generation of an odor and the like in the hot melt adhesive to improve the stability of the hot melt adhesive. Stabilizers that may be used in the compositions disclosed herein are not particularly limited. Examples of stabilizers useful in the compositions disclosed herein include an antioxidant, an ultraviolet absorbing agent, or combinations thereof. The stabilizer optionally may be lactone-based. The antioxidant may be used to prevent oxidative degradation of the disclosed compositions. Examples of the antioxidant include phenol-based antioxidants, sulfur-based antioxidants, and phosphorus-based antioxidants. The ultraviolet absorbing agent may be used to improve the light resistance of the disclosed compositions. Examples of the ultraviolet absorbing agent include benzotriazole-based ultraviolet absorbing agents and benzophenone-based ultraviolet absorbing agents. Specific examples of suitable stabilizers include SUMILIZER GM (trade name), SUMILIZER TPD (trade name) and SUMILIZER TPS (trade name) manufactured by Sumitomo Chemical Co., Ltd., IRGANOX 1010 (trade name), IRGANOX HP2225FF (trade name), IRGAFOS 168 (trade name), IRGANOX 1520 (trade name) and TINUVIN P manufactured by Ciba Specialty Chemicals, JF77 (trade name) manufactured by Johoku Chemical Co., Ltd., TOMINOX TT (trade name) manufactured by API Corporation and AO-4125 (trade name) manufactured by ADEKA CORPORATION.

Oils useful in the compositions disclosed herein may include unsaturated renewable oils such as sunflower oil, safflower oil, soybean oil, linseed oil, castor oil, orange oil, rapeseed oil, tall oil, vegetable processing oil, vulcanized vegetable oil, high oleic acid sunflower oil, cottonseed oil, nut oils, and combinations thereof. Useful oils may include mineral oils such as Novadex B111 or Catenex T129 (available from Shell).

As noted above, the composition may comprise at least one additive. Such additives, if present at all, may be present in the composition in a combined amount of at least 0.01 percent by weight based on total weight of the composition, such as at least 0.05 percent by weight, and may be present in the composition in a total amount of no more than 12 percent by weight based on total weight of the composition, such as no more than 3 percent by weight. Such additives, if present at all, may be present in the composition in a combined amount of 0.01 percent by weight to 12 percent by weight based on total weight of the composition, such as 0.05 percent by weight to 10 percent by weight.

### Compositions

As discussed above, the compositions disclosed herein may comprise an epoxy-functional polyester, elastomeric particles, and an accelerator. In addition to the epoxy-functional polyester, the composition optionally may comprise an epoxy-containing compound (as described above) and/or the elastomeric particles may optionally be included in an epoxy carrier resin for introduction into the composition. Thus, the total of epoxy-containing materials in the coating composition (i.e., the total of the epoxy-functional polyester, the epoxy-containing compound, and the epoxy carrier resin) may be at least 20 percent by weight based on total weight of the composition, such as at least 25 percent by weight, and may be no more than 90 percent by weight based on total weight of the composition, such as no more than 67 percent by weight. Thus, the total of epoxy-containing materials in the coating composition (i.e., the total of the epoxy-functional polyester, the epoxy-containing compound, and the epoxy carrier resin) may be 20 percent by weight to 90 percent by weight based on total weight of the composition, such as 25 percent by weight to 67 percent by weight.

### Methods and Systems

Also disclosed is a method for preparing a one-component composition comprising, or in some cases consisting of, or in some cases consisting essentially of, an epoxy-functional polyester, elastomeric particles, and an accelerator, and any of the optional further components, if used, described above, the method comprising, or in some cases consisting essentially of, or in some cases consisting of, mixing the epoxy-functional polyester, elastomeric particles, and accelerator, and any of the optional further components. The components may be mixed together in any order.

The composition described above may be applied alone or as part of a system that can be deposited in a number of different ways onto a number of different substrates. The system may comprise a number of the same or different films, coatings, or layers.

The present disclosure also is directed to a method for coating a substrate comprising, or consisting essentially of, or consisting of, contacting at least a portion of a surface of the substrate with one of the compositions described hereinabove. The composition may be applied to at least a portion of the surface of a substrate in any number of different ways, non-limiting examples of which include brushes, rollers, films, pellets, trowels, spatulas, dips, extruders, spray guns and applicator guns.

The present disclosure is also directed to a method for forming a bond between two substrates for a wide variety of potential applications in which the bond between the substrates provides particular mechanical properties related to lap shear or peel strength or impact resistance. The method may comprise, or consist essentially of, or consist of, applying the composition described above to a first substrate; contacting a second substrate to the composition such that the composition is located between the first substrate and the second substrate; and applying sufficient pressure for the composition to intimately contact both substrates. For example, the composition may be applied to either one or both of the substrate materials being bonded to form an adhesive bond there between and the substrates may be aligned and pressure and/or spacers may be added to control bond thickness. The composition may be applied to cleaned or uncleaned (i.e., including oily or oiled) substrate surfaces. The composition also may be applied to a substrate that has been pretreated, coated with an electrodepositable coating, and/or coated with additional layers such as a primer, basecoat, or topcoat.

A coating, film, layer or the like may be formed when a composition that is deposited onto the substrate is at least partially cured, e.g., by using an external energy source. Such external energy sources include energy sources known to those of ordinary skill in the art, such as by thermal heating (such as an oven) or through the use of actinic radiation. For example, the composition can be cured by baking and/or curing at elevated temperature, such as at a temperature of at least 80° C., such as at least 100° C., such as at least 120° C., such as at least 125° C., such as at least 130° C., and in some cases at a temperature of no more than 250° C., such as no more than 210° C., such as no more than 205° C., such as no more than 200° C., such as no more than 195° C., and in some cases at a temperature of from 80° C. to 250° C., from 100° C. to 210° C., from 120° C. to 205° C., from 125° C. to 200° C., from 130° C. to 195° C., and for any desired time period (e.g., from 1 minute to 5 hours) sufficient to at least partially cure the coating composition on the substrate(s). The skilled person understands, however, that the time of curing varies with temperature. The coating, layer, or film may be, for example, an adhesive, such as a structural adhesive.

It has been surprisingly discovered that the compositions disclosed herein which comprise a sag control agent have a sag of 5 mm or less when tested according to SAE J243 ADS-10 (Test Method B) modified using a scraper having a radius of 6 mm as shown in FIG. 1, such as a sag of 4 mm or less, such as a sag of 3 mm or less, such as a sag of 2 mm or less, such as a sag of 1 mm or less.

It has been surprisingly discovered that the compositions disclosed herein provide, in an at least partially cured state, a coating that provides particular mechanical properties, including an impact resistance at 23° C. of greater than 10 N/mm measured according to ISO 11343 using 0.8 mm thick cold rolled steel (CRS), such as at least 15 N/mm, such as at least 17 N/mm, such as at least 20 N/mm, and including an impact resistance at −40° C. of greater than 10 N/mm measured according to ISO 11343 using 0.8 mm thick CRS, such as at least 12 N/mm, such as at least 15 N/mm.

It also has been surprisingly discovered that the compositions disclosed herein provide, in an at least partially cured state, a coating that has a lap shear strength of greater than 12 MPa measured according to ASTM D1002 using 0.8 mm thick hot-dip galvanized steel, such as at least 13 MPa, such as at least 14 MPa, such as at least 15 MPa, such as at least 16 MPa, such as at least 17 MPa, such as at least 18 MPa.

It also has been surprisingly discovered that the compositions disclosed herein provide, in at least partially cured state, a coating that has a T-peel strength (measured at room temperature) of at least 4 N/mm measured according to ASTM D1876 using 0.8 mm thick hot-dip galvanized steel, such as at least 5 N/mm, such as at least 6 N/mm.

### Substrates

The substrates that may be coated by the compositions disclosed herein are not limited. Suitable substrates include, but are not limited to, materials such as metals or metal alloys, polymeric materials such as hard plastics including filled and unfilled thermoplastic materials or thermoset materials, or composite materials. Other suitable substrates include, but are not limited to, glass or natural materials such as wood. For example, suitable substrates include rigid metal substrates such as ferrous metals, aluminum, aluminum alloys, magnesium titanium, copper, and other metal and alloy substrates. The ferrous metal substrates used may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. Aluminum alloys of the 1XXX, 2XXX, 3XXX, 4XXX, 5XXX, 6XXX, 7XXX, or 8XXX series as well as clad aluminum alloys and cast aluminum alloys of the A356, 1XX.X. 2XX.X, 3XX.X, 4XX.X, 5XX.X, 6XX.X, 7XX.X, or 8XX.X series also may be used as the substrate. Magnesium alloys of the AZ31B, AZ91C, AM60B, or EV31A series also may be used as the substrate. The substrate also may comprise titanium and/or titanium alloys of grades 1-36 including H grade variants. Other suitable non-ferrous metals include copper and magnesium, as well as alloys of these materials. In examples, the substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2). Suitable substrates include those that are used in the assembly of vehicles, batteries, and electronics. For example, suitable substrates include without limitation vehicular battery, vehicular door, body panels, trunk deck lid, roof panel, hood, roof and/or stringers, rivets, landing gear components, and/or skins used on an aircraft, a vehicular frame, vehicular parts, motorcycles, and industrial structures and components. As used herein, “vehicle” or variations thereof includes, but is not limited to, civilian, commercial, and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091. The substrate may be coated, such as with a primer or paint, such as an electrodeposited primer coating. The substrate may comprise a composite material such as a plastic or a fiberglass composite. The substrate may be a fiberglass and/or carbon fiber composite. The substrate may be a vehicle, a part, an article, an appliance, a personal electronic device, a circuit board, a battery box, a multi-metal article, or combinations thereof. The compositions disclosed herein are particularly suitable for use in various industrial or transportation applications including automotive, light and heavy commercial vehicles, marine, or aerospace.

Illustrating the disclosed subject matter are the following examples that are not to be considered as limiting the disclosure to their details. All parts and percentages in the examples, as well as throughout the specification, are by weight unless otherwise indicated.

### EXAMPLES

In the Examples, the following instruments were used to monitor reaction progress: acid value titration (equipment, Metrohm 888 Titrando; reagent, 0.1 N KOH solution in methanol); epoxide equivalent titration (equipment, Metrohn 888 Titrando; reagent, 0.1 N perchloric acid in glacial acetic acid).

Epoxy-functional polyesters were synthesized according to Examples A and B described herein.

### Example A

In Example A, epoxy-functional polyesters A1 to A7 were prepared using the material listed in Table 1 and as described below.

TABLE 1
Epoxy-Functional Polyesters A1 to A7.

| | Example | | | | | | |
|---|---|---|---|---|---|---|---|
| Ingredients | A1 | A2 | A3 | A4 | A5 | A6 | A7 |

Charge #1

| | | | | | | | |
|---|---|---|---|---|---|---|---|
| MHHPA ¹ | 84.1 | | | | | | |
| Succinic anhydride² | | 141.1 | | | | | |
| 5-Norbornene-2,3- | | | 164.2 | | | | |
| dicarboxylic acid | | | | | | | |
| anhydride ³ | | | | | | | |
| 1,2,3,6- | | | | 152.2 | | | |
| Tetrahydrophthalic | | | | | | | |
| anhydride ⁴ | | | | | | | |
| Phthalic anhydride ⁵ | | | | | 148.1 | | |
| Maleic anhydride ⁶ | | | | | | 98.1 | |
| HHPA ⁷ | | | | | | | 61.6 |
| Poly DB 2035 TPU ¹¹ | | | | | | | 93.0 |
| Epon 828 ⁸ | 359.5 | 1013.7 | 718.9 | 718.9 | 718.9 | 718.9 | 287.6 |

Charge #2

| | | | | | | | |
|---|---|---|---|---|---|---|---|
| Capa 2077A ⁹ | 183.0 | 516.0 | 365.9 | 365.9 | 365.9 | 365.9 | 146.4 |

Charge #3

| | | | | | | | |
|---|---|---|---|---|---|---|---|
| Epon 828 | 35.1 | 99.0 | 70.2 | 70.2 | 70.2 | 70.2 | 28.1 |
| Triphenylphosphine | 0.11 | 0.176 | 0.21 | 0.19 | 0.19 | 0.12 | 2.6 |
| Epoxide Equivalent | 412.0 | 404.5 | 414.0 | 414.8 | 425.9 | 417.2 | 473.5 |
| Weight (EEW) | | | | | | | |
| Mw | 4097 | 4723 | 3733 | 4006 | 4871 | 4931 | 4648 |

¹ Methylhexahydrophthalic anhydride, commercially available from Dixie Chemical.
²Commercially available from Lonza.
³ Commercially available from TCI.
⁴ Commercially available from EMD Millipore Corporation.
⁵ Commercially available from BASF.
⁶ Commercially available from Hunstman.
⁷ Hexahydrophthalic anhydride, commercially available from Dixie Chemical.
⁸ A Bisphenol A-epichlorohydrin resin commercially available from HEXION SPECIALTY CHEMICALS.
⁹ A polyester polyol commercially available from Perstorp.
¹⁰ Commercially available from Sigma Aldrich.
¹¹ A thermoplastic polyurethane resin commercially available from Arkema group.

For each of Examples A1 to A7, charge #1 was added to a suitable, 4-necked kettle equipped with a motor driven stainless steel stir blade, a water-cooled condenser, a nitrogen blanket, and a heating mantle with a thermometer connected through a temperature feedback control device. The contents of the flask were heated to 90° C. and held for 30 minutes. Charge #2 was added, and the reaction mixture was held at 90° C. Charge #3 was added, and the mixture was heated to 120° C. after exotherm. Then, the reaction mixture was held at 120° C. until the acid value was less than 2 mg KOH/g by titration using a Metrohm 888 Titrando and 0.1 N KOH solution in Methanol as the titration reagent. The reaction temperature was cooled to 80° C. and the resin was poured out from the flask. The epoxide equivalent weight was determined by titration using a Metrohm 888 Titrando and 0.1N perchloric acid in glacial acetic acid. The weight average molecular weight was measured by Gel Permeation Chromatography using a Waters 2695 separation module with a Waters 410 differential refractometer (RI detector) and polystyrene standards. Tetrahydrofuran (THF) was used as the eluent at a flow rate of 1 ml min⁻¹, and two PL Gel Mixed C columns were used for separation.

### Example B

In Example B, epoxy-functional polyesters B1 to B7 were prepared using the material listed in Table 2 and as described below.

TABLE 2
Epoxy-Functional Polyesters B1 to B7.

| | Example | | | | | | |
|---|---|---|---|---|---|---|---|
| Ingredients | B1 | B2 | B3 | B4 | B5 | B6 | B7 |

Charge #1

| | | | | | | | |
|---|---|---|---|---|---|---|---|
| MHHPA | 252.3 | | | | | | |
| Succinic anhydride | | 100.1 | | | | | |
| 5-Norbornene-2,3- | | | 164.2 | | | | |
| dicarboxylic acid | | | | | | | |
| anhydride | | | | | | | |
| Tetrahydrophthalic | | | | 152.2 | | | |
| anhydride | | | | | | | |
| Phthalic anhydride | | | | | 148.1 | | |
| Maleic anhydride | | | | | | 98.1 | |
| HHPA | | | | | | | 107.8 |
| Epon 828 | 1078.4 | 718.9 | 718.9 | 718.9 | 718.9 | 718.9 | 534.0 |

Charge #2

| | | | | | | | |
|---|---|---|---|---|---|---|---|
| Capa ™ 4101 ¹² | 386.0 | 257.3 | 257.3 | 257.3 | 257.3 | 257.3 | 175.0 |

Charge #3

| | | | | | | | |
|---|---|---|---|---|---|---|---|
| Epon 828 | 770.8 | 340.1 | 340.11 | 340.1 | 340.1 | 340.1 | 45.0 |
| Triphenylphosphine | 0.32 | 0.13 | 0.41 | 0.38 | 0.4 | 0.25 | 4.5 |
| EEW | 298.7 | 315 | 319.7 | 319.1 | 322.5 | 317.4 | 376.7 |
| Mw | 7001 | 45757 | 9626 | 10403 | 17573 | 24013 | 8674 |

¹² A polyester polyol commercially available from Perstorp.

For each of Examples B1 to B7, Charge #1 was added to a suitable, 4-necked kettle equipped with a motor driven stainless steel stir blade, a water-cooled condenser, a nitrogen blanket, and a heating mantle with a thermometer connected through a temperature feedback control device. The contents of flask were heated to 90° C. and held for 30 minutes. Charge #2 was added, and the reaction mixture was held at 90° C. Charge #3 was added, and the mixture was heat to 120° C. after exotherm. Then, the reaction mixture was held at 120° C. until the acid value is less than 2 mg KOH/g by titration as described in Example A. The reaction temperature was cooled to 80° C. and the resin was poured out from flask. The epoxy equivalent weight and weight average molecular weight of the epoxy functional polyester were measured as described in Example A.

### Example 1

The ingredients for adhesive compositions used in Example 1 are provided in

Table 3. The materials as used in the Examples are explained below in paragraph in detail. The adhesive compositions described below were prepared according to the following procedure with all non-manual mixing performed using a DAC 600FVZ Speedmixer (commercially available from FlackTech, inc.). Ingredients listed under “Epoxy Resins” were combined and mixed for at least 2 minutes at 2350 RPM. Ingredients listed as “Fillers,” “Accelerators,” and “Adhesion Promoters” were then added to a plastic cup and then were mixed with the epoxy resin mixture for at least 2 minutes at 2350 RPM. The mixture was examined visually and given additional mix time, if necessary, to ensure uniformity.

TABLE 3
Adhesive Compositions of Example 1 (ingredients
reported in parts by weight).

| | Adhesive Example | | | Comparative |
|---|---|---|---|---|
| | #1 | #2 | #3 | Example |
| Epoxy Resin | | | | |
| Kane Ace MX 153 | 41.40 | 41.40 | 41.40 | 41.40 |
| Epoxy functional polyester | 9.15 | 9.15 | 9.15 | 9.15 |
| A1 from Example A | | | | |
| Epoxy functional polyester | 10.89 | 10.89 | 10.89 | 10.89 |
| B1 from Example B | | | | |
| jER ®YX7105 | 16.00 | | | |
| jER ®YX7110 | | 16.00 | | |
| jER ®YX7400 | | | 16.00 | |
| Epoxy Resin 828 | | | | 16.00 |
| Fillers | | | | |
| Wollastonite NYAD 400 | 13.00 | 13.00 | 13.00 | 13.00 |
| Dakota PURETM3000 | 2.00 | 2.00 | 2.00 | 2.00 |
| Ground Limestone | 2.00 | 2.00 | 2.00 | 2.00 |
| Aerosil R 202 | | | | |
| Accelerators | | | | |
| Dyhard ®100SF | 5.50 | 5.50 | 5.50 | 5.50 |
| Ajicure PN-50 | 1.15 | 1.15 | 1.15 | 1.15 |
| Adhesion promoter | | | | |
| FK-RAM 1087 | 2.00 | 2.00 | 2.00 | 2.00 |

Adhesive compositions were applied to cleaned and oiled cold rolled steel (CRS) substrates (ACT Test Panels, Inc.) prepared according to ISO 11343. The substrates were heated at 171° C. for 20 minutes in an electric oven and were conditioned at room temperature overnight before testing.

Substrates were tested according to ISO 11343 Dynamic Resistance to Cleavage testing using an INSTRON CEAST 9350 drop tower model at an impact speed of 2 m/sec. Data are reported in Table 4.

TABLE 4
Dynamic Resistance to Cleavage (DRTC) Results (Example 1).

| | Adhesive Example | | | Comparative |
|---|---|---|---|---|
| ISO 11343 DRTC | #1 | #2 | #3 | Example #1 |
| 23° C. (N/mm) | 21.69 | 20.96 | 18.68 | 17.56 |
| −40° C. (N/mm) | 16.72 | 16.08 | 13.63 | 9.79 |

The data from Example 1 demonstrate that adhesive compositions formulated using an epoxy-functional polyester maintained ISO 11343 DRTC values measured under frozen conditions (i.e. −40° C.) compared to an adhesive composition formulated using a bisphenol A di-glycidyl ether, which demonstrated a reduced DRTC value of less than 10 N/mm.

### Example 2

The ingredients for adhesive compositions used in Example 2 are provided in Table 5. The adhesive compositions described below were prepared according to the following procedure with all non-manual mixing performed using a DAC 600FVZ Speedmixer (commercially available from FlackTek, Inc.). Ingredients listed under “Epoxy Resins” were combined and mixed for at least 2 minutes at 2350 RPM. Ingredients listed as “Fillers” and “Accelerators” were then added to a plastic cup and then were mixed with the epoxy resin mixture for at least 2 minutes at 2350 RPM. The mixture was examined visually and given additional mix time, if necessary, to ensure uniformity.

TABLE 5
Adhesive compositions of Example 2 (ingredients reported in parts by weight).

| Comparative # 2 (prepared according to U.S. | | | |
|---|---|---|---|
| 20160083633 Example #1, Table 5) | | Adhesive # 4 | |
| Epoxy Resins | | Epoxy Resins | |
| Kane Ace MX 153 | 48.00 | Kane Ace MX 153 | 48.00 |
| Dimer Acid/Epon Resin 828 | 1.5 | | |
| CTBN/Epon Resin 828 | 3.5 | | |
| Terathane 650/HHPA/Epon Resin | 13.40 | Epoxy functional polyester A7 from | 8.40 |
| 828 | | Example A | |
| | | Epoxy functional polyester B7 from | 10.00 |
| | | Example B | |
| Fillers | | Fillers | |
| Mica A-325 | 1.00 | Mica A-325 | 1.00 |
| Calcium oxide | 2.00 | Calcium oxide | 2.00 |
| Fumed silica HDK H 17 | 0.50 | Fumed silica HDK H 17 | 0.50 |
| Accelerators | | Accelerators | |
| Micronized Dicyanamide | 3.40 | Micronized Dicyanamide | 4.00 |
| Diuron | 0.30 | Diuron | 0.30 |
| Ajicure PN 40 | 1.50 | Ajicure PN 40 | 1.35 |
| Ajicure MY 25 | 0.50 | Ajicure MY 25 | — |
| Total weight | 75.60 | Total weight | 75.35 |

The adhesive compositions prepared in Example 2 were evaluated for storage stability by measuring viscosity changes over time. Viscosity of each of the adhesive compositions prepared in Example 2 was measured immediately following preparation. One sample of each of Adhesive #4 and Comparative Example #2 was stored at 43° C. for 3 days and another sample of each was stored at 35° C. for 18 days. Viscosity was measured using an Anton Paar MCR Rheometer 302 model and a parallel plate at 35° C. Data are reported in Table 6.

Adhesive compositions from Example 2 were applied to cleaned and oiled cold-rolled steel (CRS), hot-dip galvanized steel (HDG), and/or electro galvanized steel (EZG) substrates (ACT Test Panels, Inc.) as denoted. The substrates were heated at 130° C. for 17 minutes in an electric oven and were conditioned at room temperature overnight before testing. Adhesive performance for Adhesive Composition #4 and Comparative Example #2 were tested according to ASTM D1002 (lap shear) and ASTM D1876 (T-peel). Data are reported in Table 7.

TABLE 6
Storage Stability of Adhesive Compositions of Example 2.

| | Comparative | Adhesive |
|---|---|---|
| | Example # 2 | Composition # 4 |
| Initial adhesive viscosity | 535 Pa · s | 586 Pa · s |
| Adhesive viscosity after | | |
| storage | | |
| 3-Days at 43° C. | 747 Pa · s | 664 Pa · s |
| 18-Day at 35° C. | 718 Pa · s | 637 Pa · s |

TABLE 7
Adhesive performance of Adhesive Compositions of Example 2.

| | Comparative Example # 2 | | Adhesive Composition # 4 | |
|---|---|---|---|---|
| | Fresh adhesive | Stored adhesive | Fresh adhesive | Stored adhesive |
| Lap Shear(MPa) | 14-20 | 17.9 | 19.3 | 19.6 |
| CRS 1 mm thick | | | | |
| T-Peel | | | | |
| HDG (N/mm) | 1.9-7.0 | Not able to bond | 6.4 | 5.3 |
| EZG (N/mm) | 2.1-9.7 | Not able to bond | 4.7 | 5.1 |
| ISO 11343 DRTC | | | | |
| RT (N/mm) | 28.0-33.0 | Not able to bond | 30.0 | 28.2 |
| −40° C. (N/mm) | 19.0-22.3 | Not able to bond | 22.6 | Did not test |

### Example 3

The ingredients for adhesive compositions used in Example 3 are provided in Table 8. The adhesive compositions described below were prepared according to the following procedure with all non-manual mixing performed using a DAC 600FVZ Speedmixer (commercially available from FlackTek, Inc.). Ingredients listed under “Epoxy Resins” were combined and mixed for at least 2 minutes at 2350 RPM. Ingredients listed as “Fillers” and “Accelerators” were then added to a plastic cup and then were mixed with the epoxy resin mixture for at least 2 minutes at 2350 RPM. The mixture was examined visually and given additional mix time, if necessary, to ensure uniformity.

TABLE 8
Adhesive compositions of Example 3 (ingredients reported in parts by weight).

| Comparative Example # 3 (prepared | | | |
|---|---|---|---|
| according to US 20160083633 Example #1, | | | |
| Table 5) | | Adhesive Example # 5 | |
| Epoxy Resins | | Epoxy Resins | |
| Kane Ace MX 153 | 48.00 | Kane Ace MX 153 | 48.00 |
| Dimer Acid/Epon Resin 828 | 1.5 | | — |
| CTBN/Epon Resin 828 | 3.5 | | — |
| Terathane 650/HHPA/Epon Resin | 13.40 | Epoxy functional polyester A7 | 8.40 |
| 828 | | from Example A | |
| | | Epoxy functional polyester B7 from | 10.00 |
| | | Example B | |
| Fillers | | Fillers | |
| Mica A-325 | 1.00 | Mica A-325 | 1.00 |
| Calcium oxide | 2.00 | Calcium oxide | 2.00 |
| Fumed silica HDK H 17 | 0.30 | Fumed silica HDK H 17 | 0.30 |
| Accelerators | | Accelerators | |
| Micronized Dicyanamide | 3.40 | Micronized Dicyanamide | 3.40 |
| Diuron | 0.30 | Diuron | 0.30 |
| Ajicure PN 50 | 1.00 | Ajicure PN 50 | 1.00 |
| Total weight | 74.40 | Total weight | 74.40 |

Adhesive compositions from Example 3 were applied to cleaned and oiled CSR substrates (ACT Test Panels, Inc.). The substrates were heated at 145° C. for 17 minutes in an electric oven and were conditioned at room temperature overnight before testing. Adhesive performance for Adhesive Composition #5 and Comparative Example #3 were tested according to ASTM D1002 (lap shear) and ASTM D1876 (T-peel). Data are reported in Table 9.

TABLE 9
Adhesive performance of Adhesive Compositions of Example 3.

| Comparative Example # 3 | | | Adhesive Composition # 5 | |
|---|---|---|---|---|
| 140° C. - 17 min | 145° C. - 17 min | Bake Condition | 140° C. - 17 min | 145° C. - 17 min |
| | | Lap Shear | | |
| | | (MPa) | | |
| 19.7 | 24.4 | CRS RT | 20.2 | 24.7 |
| | | T-Peel (N/mm) | | |
| 4.6 | 9.0 | HDG RT | 6.8 | 10.2 |
| 7.4 | 11.2 | EZG RT | 8.2 | 7.0 |
| | | ISO 11343 | | |
| | | DRTC (N/mm) | | |
| 23.7 | 35.5 | CRS RT | 31.3 | 35.5 |
| 14.5 | 24.5 | CRS −40° C. | 23.2 | 35.2 |

### Example 4

The ingredients for adhesive compositions used in Example 4 are provided in Table 10. The adhesive compositions described below were prepared according to the following procedure with all non-manual mixing performed using a DAC 600FVZ Speedmixer (commercially available from FlackTek, Inc.). Ingredients listed under “Epoxy Resins” were combined and mixed for at least 2 minutes at 2350 RPM. Ingredients listed as “Fillers” and “Accelerators” were then added to a plastic cup and then were mixed with the epoxy resin mixture for at least 2 minutes at 2350 RPM. The mixture was examined visually and given additional mix time, if necessary, to ensure uniformity.

TABLE 10
Adhesive compositions of Example 4 (parts by weight).

| | | Adhesive | | | | Adhesive |
|---|---|---|---|---|---|---|
| | Adhesive | Composition | Adhesive | Adhesive | Adhesive | Composition |
| | Composition | # 7 | Composition | Composition | Composition | # 11 |
| | # 6 | (comparative) | # 8 | # 9 | # 10 | (comparative) |
| Epoxy Resins | | | | | | |
| Kane Ace | 63.00 | 63.00 | 63.00 | 63.00 | 63.00 | 63.00 |
| MX 153 | | | | | | |
| Epoxy | 13.00 | — | — | — | — | — |
| polyester | | | | | | |
| A1 from | | | | | | |
| Example A | | | | | | |
| Epoxy | 11.00 | — | — | — | — | — |
| polyester | | | | | | |
| B1 from | | | | | | |
| Example B | | | | | | |
| Epoxy | | 13.00 | — | — | — | — |
| polyester | | | | | | |
| A2 from | | | | | | |
| Example A | | | | | | |
| Epoxy | | 11.00 | — | — | — | — |
| polyester | | | | | | |
| B2 from | | | | | | |
| Example B | | | | | | |
| Epoxy | — | — | 13.00 | — | — | — |
| polyester | | | | | | |
| A3 from | | | | | | |
| Example A | | | | | | |
| Epoxy | — | — | 11.00 | — | — | — |
| polyester | | | | | | |
| B3 from | | | | | | |
| Example B | | | | | | |
| Epoxy | — | — | — | 13.00 | — | — |
| polyester | | | | | | |
| A4 from | | | | | | |
| Example A | | | | | | |
| Epoxy | — | — | — | 11.00 | — | — |
| polyester | | | | | | |
| B4 from | | | | | | |
| Example B | | | | | | |
| Epoxy | — | — | — | — | 13.00 | — |
| polyester | | | | | | |
| A5 from | | | | | | |
| Example A | | | | | | |
| Epoxy | — | — | — | — | 11.00 | — |
| polyester | | | | | | |
| B5 from | | | | | | |
| Example B | | | | | | |
| Epoxy | — | — | — | — | — | 13.00 |
| polyester | | | | | | |
| A6 from | | | | | | |
| Example A | | | | | | |
| Epoxy | — | — | — | — | — | 11.00 |
| polyester | | | | | | |
| B6 from | | | | | | |
| Example B | | | | | | |
| Fillers | | | | | | |
| Wollastonite | 5.50 | 5.50 | 5.50 | 5.50 | 5.50 | 5.50 |
| NYAD 400 | | | | | | |
| Aerosil R | 1.00 | 1.00 | 1.00 | 1.00 | 1.00 | 1.00 |
| 202 | | | | | | |
| Accelerators | | | | | | |
| Micronized | 5.50 | 5.50 | 5.50 | 5.50 | 5.50 | 5.50 |
| Dicyanamide | | | | | | |
| Ajicure | 1.00 | 1.00 | 1.00 | 1.00 | 1.00 | 1.00 |
| PN-50 | | | | | | |

Adhesive compositions were applied to cleaned and oiled cold rolled steel (CRS) substrates (ACT Test Panels, Inc.) prepared according to ISO 11343. The substrates were heated at 155° C. for 17 minutes in an electric oven and were conditioned overnight at room temperature before testing.

Substrates were tested according to ISO 11343 Dynamic Resistance to Cleavage testing using an INSTRON CEAST 9350 drop tower model at an impact speed of 2 m/sec. Data are reported in Table 11.

TABLE 11
Dynamic Resistance to Cleavage (DRTC)
Results (N/mm) (Example 4)

| Epoxy | Adhesive formulated with Epoxy Polyester | | | | | |
|---|---|---|---|---|---|---|
| Polyester | #6 | #7 | #8 | #9 | #10 | #11 |
| DRTC 23° C. | 25.76 | — | 36.82 | 34.52 | 30.12 | — |
| DRTC −40° C. | 28.43 | — | 36.11 | 33.37 | 15.26 | — |

— Indicates no measurable resistance.

The results of Example 4 demonstrated the importance of the polyester formed from a ring-fused anhydride structure in achieving ISO 11343 DRTC performance.

### Example 5

The ingredients for adhesive compositions used in Example 5 are provided in Table 12. The adhesive compositions described below were prepared according to the following procedure with all non-manual mixing performed using a DAC 600FVZ Speedmixer (commercially available from FlackTek, Inc.). Ingredients listed under “Epoxy Resins” were combined and mixed for at least 2 minutes at 2350 RPM. Ingredients listed as “Fillers” and “Accelerators” were then added to a plastic cup and then were mixed with the epoxy resin mixture for at least 2 minutes at 2350 RPM. The mixture was examined visually and given additional mix time, if necessary, to ensure uniformity.

TABLE 12
Adhesive compositions of Example 5 (parts by weight)

| | #12 | #13 | #14 | #15 |
|---|---|---|---|---|
| Rubber | | | | |
| Kane Ace MX 153 | 65.00 | | | |
| Resinous Bond RKB | | 65.00 | | |
| 1033* | | | | |
| Resinous Bond RKB | | | 65.00 | |
| 304H* | | | | |
| Resinous Bond RKB | | | | 65.00 |
| 1133* | | | | |
| Epoxy Resins | | | | |
| Epoxy polyester A1 | 11.44 | 11.44 | 11.44 | 11.44 |
| Epoxy polyester B1 | 13.62 | 13.62 | 13.62 | 13.62 |
| Accelerators | | | | |
| Micronized | 4.63 | 4.63 | 4.63 | 4.63 |
| Dicyanamide | | | | |
| Ajicure PN-50 | 1.36 | 1.36 | 1.36 | 1.36 |
| Diuron | 0.31 | 0.31 | 0.31 | 0.31 |
| Fillers | | | | |
| DAKOTA | 2.72 | 2.72 | 2.72 | 2.72 |
| PURE ™3000 Mica | | | | |
| Aerosil R 202 | 0.90 | 0.90 | 0.90 | 0.90 |

*Micronized ground butadiene copolymer rubber particle dispersed epoxy resin, Resinous Bond RKB 1033, RKB 304H and RKB 1133 were employed, and these are available from Resinous Kasei Co., Ltd. (Japan).

Adhesive compositions were applied to cleaned and oiled cold rolled steel (CRS) substrates (ACT Test Panels, Inc.) prepared according to ISO 11343. The substrates were heated at 160° C. for 20 minutes in an electric oven and were conditioned overnight at room temperature before testing.

Substrates were tested according to ISO 11343 Dynamic Resistance to Cleavage testing using an INSTRON CEAST 9350 drop tower model at an impact speed of 2 m/sec. Data are reported in Table 13.

TABLE 13
Dynamic Resistance to Cleavage (DRTC)
Results (N/mm) (Example 5)

| DRTC (N/mm) | #12 | #13 | #14 | #15 |
|---|---|---|---|---|
| RT | 24.4 | 15.5 | 13.7 | 14.3 |
| −40° C. | 20.5 | — | — | — |

Adhesive compositions containing core shell rubber particles dispersed in epoxy resin showed improved ISO 11343 DRTC resistance, particularly under frozen conditions compared to adhesive compositions containing micronized ground rubber particles dispersed in epoxy resin, which did not demonstrate any recordable DRTC values under −40° C.

Materials used in Examples:
Kane Ace MX 153 core shell rubber dispersed epoxy resin, available from Kaneka Texas
Flexible and elastic jER® epoxy resins, available from Mitsubishi Chemical Co., Ltd.
Epon Resin 828 Bisphenol A di-glycidyl ether available from Hexion
Wollastonite NYAD 400 Calcium metasilicate, available from IMERS
Dakota PURE™3000 Mica, available from Pacer Minerals
Aerosil® R 202 fume silica, available from EVONIK
Dyhard®100SF Micronized Dicyanamide available from AlzChem
Ajicure PN-50 Micronized accelerator for epoxy/Dicy cure, available from A&C Catalysts and Ajinomoto Fine Chemical
FK-RAM 1087 Epoxy silane adhesion promoter, available from Huntsman Advanced Materials
Resinous Bond RKB 1033, RKB 304H and RKB 1133 were employed, and these are available from Resinous Kasei Co., Ltd. (Japan). See Table 14.

TABLE 14
Epoxy Resins

| | RKB 1033 | RKB 304H | RKB 1133 |
|---|---|---|---|
| Epoxy Resin | BPA Epoxy | BPA Epoxy/BPF | BPF Epoxy |
| | | Epoxy | |
| Butadiene copolymer | 30.0 Wt. % | 28.6 wt. % | |
| Epoxy Eq. Wt. | | 232 | 240 |

### Example 6

The ingredients for adhesive compositions used in Example 6 are provided in Table 15. The adhesive compositions described below were prepared according to the following procedure with all non-manual mixing performed using a DAC 600FVZ Speedmixer (commercially available from FlackTek, Inc.). Ingredients listed under “Epoxy Resins” were combined and mixed for at least 2 minutes at 2350 RPM. Ingredients listed as “Fillers/Thixotrope/Sag Control Agent” and “Accelerators” were then added to a plastic cup and then were mixed with the epoxy resin mixture for at least 2 minutes at 2350 RPM. The mixture was examined visually and given additional mix time, if necessary, to ensure uniformity.

TABLE 15
Adhesive compositions of Example 4 (parts by weight).

| | Adhesive | Adhesive |
|---|---|---|
| | Composition | Composition |
| | # 6 | # 12 |
| Epoxy Resins | | |
| Kane Ace MX 153 | 63.00 | 63.00 |
| Epoxy polyester A1 | 13.00 | 13.00 |
| from Example A | | |
| Epoxy polyester B1 | 11.00 | 11.00 |
| from Example B | | |
| Fillers/Thixotrope/Sag Control Agent | | |
| Wollastonite NYAD 400 | 5.50 | 5.50 |
| Aerosil R 202 | 1.00 | 5.20* |
| Accelerators | | |
| Micronized Dicyanamide | 5.50 | 5.50 |
| Ajicure PN-50 | 1.00 | 1.00 |
| Adhesive sag during cure | 32 mm | 1.5 mm |

*Sag control agent

Adhesive Compositions #6 and #12 were applied to oiled electro galvanized steel (EZG) substrates (ACT Test Panels, Inc.) and subjected to testing in accordance with SAE J243 ADS-10 (Test Method B) modified using the setup shown in FIG. 1 with a radius of 6 mm. The resulting adhesive bead was marked at its initial position and propped up vertically, with the adhesive bead parallel to the benchtop. Vertically positioned panels were held at room temperature for 4 hours and then transferred in the vertical position to a 155° C. oven for 17 minutes to cure. After cooling, sag of the adhesive bead was measured in distance from the initial position. Data are reported in Table 15.

Whereas specific aspects of the disclosed subject matter have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims and aspects appended and any and all equivalents thereof.

1. A composition comprising:
an epoxy-functional polyester comprising a reaction product of a reaction mixture comprising a polyester, a ring-fused anhydride, and an epoxy;
elastomeric particles; and
an accelerator.

2. The composition of claim 1, wherein the polyester comprises a hydroxyl-terminated polyester.

3. The composition of claim 1, wherein the polyester comprises an average hydroxide functionality of greater than 1 and/or a hydroxide equivalent weight of 125 g/eq to 1250 g/eq.

4. (canceled)

5. The composition of claim 1, wherein the polyester comprises a caprolactone.

6-7. (canceled)

8. The composition of claim 1, wherein the ring-fused anhydride comprises Structure I and/or Structure II:

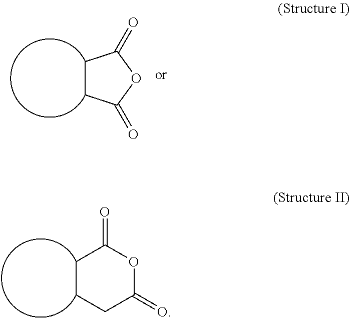 [SMILES: O=C1CCC(=O)O1 ; O=C1CCCC(=O)O1]

9. The composition of claim 1, wherein the ring-fused anhydride comprises a phthalic anhydride and/or derivatives thereof.

10-11. (canceled)

12. The composition of claim 1, wherein the composition is substantially free of an anhydride that is not ring-fused.

13. The composition of claim 1, wherein the ring-fused anhydride comprises a Mw of 100 g/mol to 600 g/mol.

14. The composition of claim 1, wherein an equivalent ratio of epoxide groups to hydroxyl groups to anhydride groups comprises 20:1:0.5 to 2:2:1.

15. (canceled)

16. The composition of claim 1, wherein the epoxy comprises an average epoxide functionality of greater than 1.0 and/or an epoxide equivalent weight of at least 90 g/eq.

17-18. (canceled)

19. The composition of claim 1, wherein the epoxy-functional polyester comprises an epoxide equivalent weight of 150 g/eq to 1500 g/eq and/or an Mw of 800 g/mol to 100,000 g/mol.

20-29. (canceled)

30. The composition of claim 1, wherein:
(a) the accelerator is present in an amount of 1 percent by weight to 15 percent by weight based on total weight of the composition;
(b) the epoxy-functional polyester is present in an amount of 5 percent by weight to 40 percent by weight based on total weight of the composition; and/or
(c) the elastomeric particles are present in an amount of 7 percent by weight to 80 percent by weight based on total weight of the composition.

31. The composition of claim 1, further comprising:
(a) filler(s) in an amount of no more than 25 percent by weight based on total weight of the composition; and/or
(b) an epoxy-containing compound that is different than the epoxy-functional polyester; and/or
(c) an additive.

32-34. (canceled)

35. The composition of claim 31, wherein the additive comprises a thixotrope and/or a sag control agent.

36-37. (canceled)

38. The composition of claim 35, wherein the composition has a sag of 5 mm or less when tested according to SAE J243 ADS-10 (Test Method B) modified using a scraper having a radius of 6 mm.

39. A method of coating a substrate comprising:
(a) contacting at least a portion of a surface of a first substrate with the composition of claim 1.

40. (canceled)

41. The method of claim 39, further comprising contacting a surface of a second substrate to the composition such that the composition is between the first and the second substrate.

42. (canceled)

43. A substrate comprising a coating, formed from the composition of claim 1, on a surface, wherein the coating in an at least partially cured state, has:
(a) an impact resistance at 23° C. of greater than 10 N/mm measured according to ISO 11343 using 0.8 mm thick CRS;
(b) an impact resistance at −40° C. of greater than 10 N/mm measured according to ISO 11343 using 0.8 mm thick CRS;
(c) a lap shear strength of greater than 12 MPa measured according to ASTM D1002 using 0.8 mm thick hot-dip galvanized steel; and/or (d) a T-peel strength at room temperature of at least 4 N/mm measured according to ASTM D1876 using 0.8 mm thick hot-dip galvanized steel.

44-46. (canceled)

47. The substrate of claim 43, wherein the substrate comprises a vehicle, a part, an article, an appliance, a personal electronic device, a circuit board, a battery box, a multi-metal article, or combinations thereof.

48. The substrate of claim 47, wherein the vehicle comprises an automobile or an aircraft.

49-50. (canceled)
